(19) United States
(12) Patent Application Publication
(10) Pub. No.: US 2008/0232370 A1
(43) Pub. Date: Sep. 25, 2008

(54) Method of communication in LAN without setting IP

(76) Inventors: Ching Hsiang Lee, Taipei City (TW); Tsu Yi Ku, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,420

(22) Filed: Mar. 20, 2007

(51) Int. Cl. H04L 12/56

(52) U.S. Cl. 370/392; 370/401

(57) ABSTRACT

A method of communication in LAN without setting IP is provided, especially for LAN with a host device and at least a peripheral device. The method includes: (1) the host device sending the peripheral device a broadcast search packet through LAN, (2) the peripheral device establishing a new routing table according to the packet, (3) the peripheral device returning a response packet containing IP data to the host device, (4) the host device establishing a new routing table according to the response packets returned from peripheral device, and (5) the host device performing wired or wireless LAN communication with peripheral device according to the new routing table. Therefore, the host device and the device can automatically detect IP data even they may belong to different sub-net to achieve the communication in LAN without setting IP.

### BACKGROUND OF THE INVENTION

1. Field of the Invention

The present invention relates to a method of communication in LAN without setting IP, and more particularly, to a method of wired or wireless communication between a host and a peripheral in LAN without setting IP.

2. The Related Arts

The local area network (LAN) system is widely used in a variety of applications, including the recent promotion of wireless digital home systems. The conventional LAN requires the setting of sub-net address of host devices and peripheral devices before the wired or wireless communication can be carried out. That is, all the host devices and devices on the LAN must be assigned the sub-net of the same IP address. However, this setting is complicated and may not be easily performed for general users; therefore, it is inconvenient for the LAN setup.

Furthermore, as the embedded devices or systems used in LAN usually do not include input and display devices, it is inconvenient to set IP for these devices or systems. For example, it is impossible to directly set IP address of digital wireless peripheral, and the network administrator must reconfigure the IP address every time a new wireless peripheral is added to the LAN. This causes tremendous amount of network maintenance overhead.

Although the user may use the dynamic host configuration protocol server (DHCP server) conforming to RFC 1541 or RFC 2131 for automatic IP management and assignment, there are two disadvantages of this type of servers. First, most users are not familiar with the DHCP server technology, and are unable to directly operate and manage the DHCP server. Therefore, the tasks must rely on professional network administrator. Second, when the network peripheral does not support DHCP client specification, or when the peripheral is manufactured with a fixed IP, no communication can be carried out.

Taiwan Patent No. I246838 disclosed a method for linking to a network without setting IP, and Taiwan Patent No. I241798 disclosed a method and apparatus of plug-and-play. However, methods disclosed in both patents shared the common disadvantages: (1) the methods are only applicable to the host device connecting to other network, but not applicable to the communication between devices and host devices in the same LAN; (2) the methods are only applicable to multiple host devices connecting to gateway, but not applicable to connections between network devices; and (3) if the host device is not pre-configured with gateway address, the methods are not applicable.

### SUMMARY OF THE INVENTION

The primary object of the present invention is to provide a method of communication in LAN without setting IP, especially for connecting a plurality of devices in a LAN for communication without the setting IP and gateway address.

Another object of the present invention is to provide a method of communication in LAN without setting IP, especially for allowing the host device and the device in LAN to automatically detect and obtain IP, applicable to home network, small office, or environment not staffed with network administrative personnel.

Yet another object of the present invention is to provide a method of communication in LAN without setting IP, especially for allowing host device and the device in LAN to communicate without connecting to gateway or additional hardware, so that it is applicable to the host device and the device connection in LAN and the digital home device connection.

To achieve the above objects, the present invention provides a method of communication in LAN without setting IP, including: (1) the host device sending the peripheral devices a broadcast search packet through LAN, (2) the peripheral devices establishing a new routing table according to the packet, (3) the peripheral devices returning a packet containing IP data to the host device, (4) the host device establishing a new routing table according to the packets returned from peripheral device, and (5) the host device performing wired or wireless LAN communication with peripheral device according to the new routing table. Therefore, the host device and the device can automatically detect IP data even they may belong to different sub-net to achieve the communication in LAN without setting IP.

These and other objects, features and advantages of the invention will be apparent to those skilled in the art, from a reading of the following brief description of the drawings, the detailed description of the best mode for carrying out the present invention, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 shows a flowchart of a method of communication in LAN without setting IP of the present invention;

FIG. 2 shows a schematic view of a system connection structure of host device and peripheral device of the present invention;

FIG. 3 shows the operation of the present invention;

FIG. 4 shows a first embodiment of the present invention; and

FIG. 5 shows a second embodiment of the present invention.

### DETAILED DESCRIPTION OF THE BEST MODE FOR CARRYING OUT THE PRESENT INVENTION

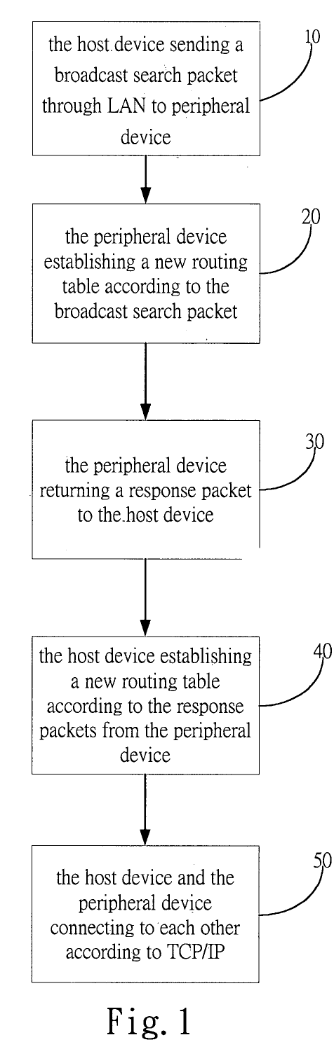

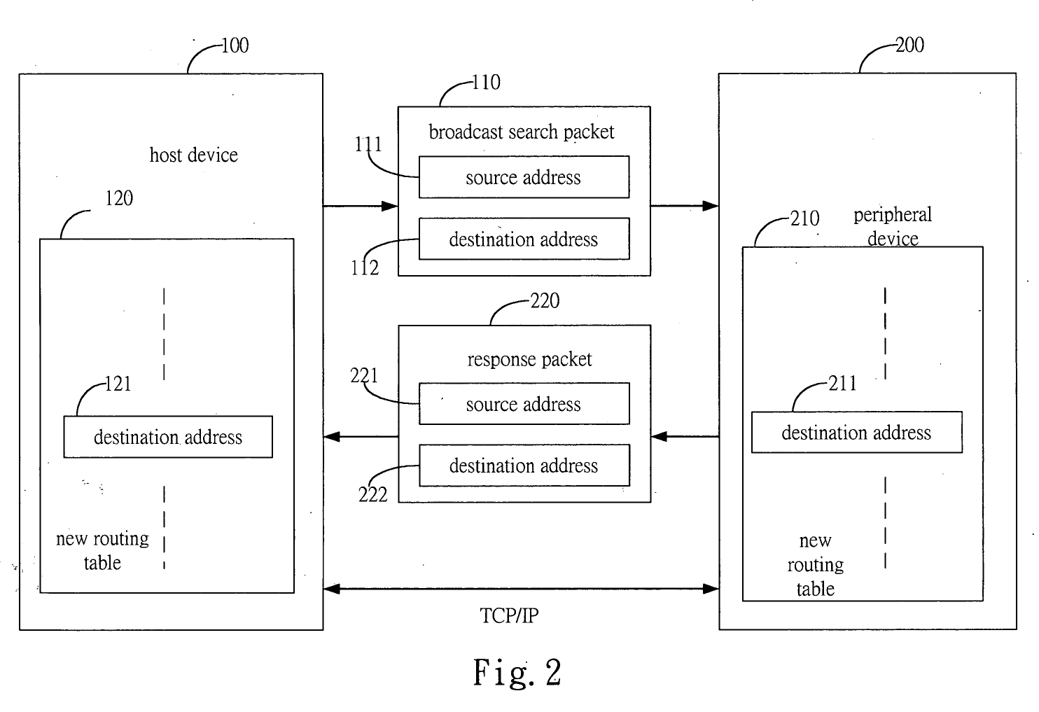

Referring to FIGS. 1 and 2, a method of communication in LAN without setting IP of the present invention includes the following steps:

Step 10: the host device sending a broadcast search packet through LAN to peripheral device; for example, in FIG. 2, a host device 100 sending a broadcast search packet 110 to at least a peripheral device 200, the broadcast search packet 110 including a source address 111 and a destination address 112;

Step 20: the peripheral device establishing a new routing table according to the broadcast search packet; for example, the peripheral device 200 establishing a new routing table 210 according to the source address 111 of the broadcast search packet 110 from the host device 100, the new routing table 210 setting a path for packets from the peripheral device 200 to the host device 100, with the source address 111 of the broadcast search packet 110 as its destination address 211;

Step 30: the peripheral device returning a response packet to the host device; for example, the peripheral device 200 returning a response packet 220 to the host device 100 according to the routing table 210; the response packet 220 including a source address 221 and a destination address 222, and the destination address being the source address 111 of the broadcast packet 110 of step 10;

Step 40: the host device establishing a new routing table according to the response packets from the peripheral devices; for example, the host device 100 establishing a new routing table 120 according to the source address 221 of the response packet 220, the routing table 120 setting a path for packets from the host device 100 to the peripheral device 200, with the source address 221 of the response packet 220 as its destination address 121; and

Step 50: the host device and the peripheral device connecting to each other according to TCP/IP; for example, the host device 100 using the routing table 120 and the peripheral device 200 using the routing table 210 to connect and communicate with each other according to TCP/IP.

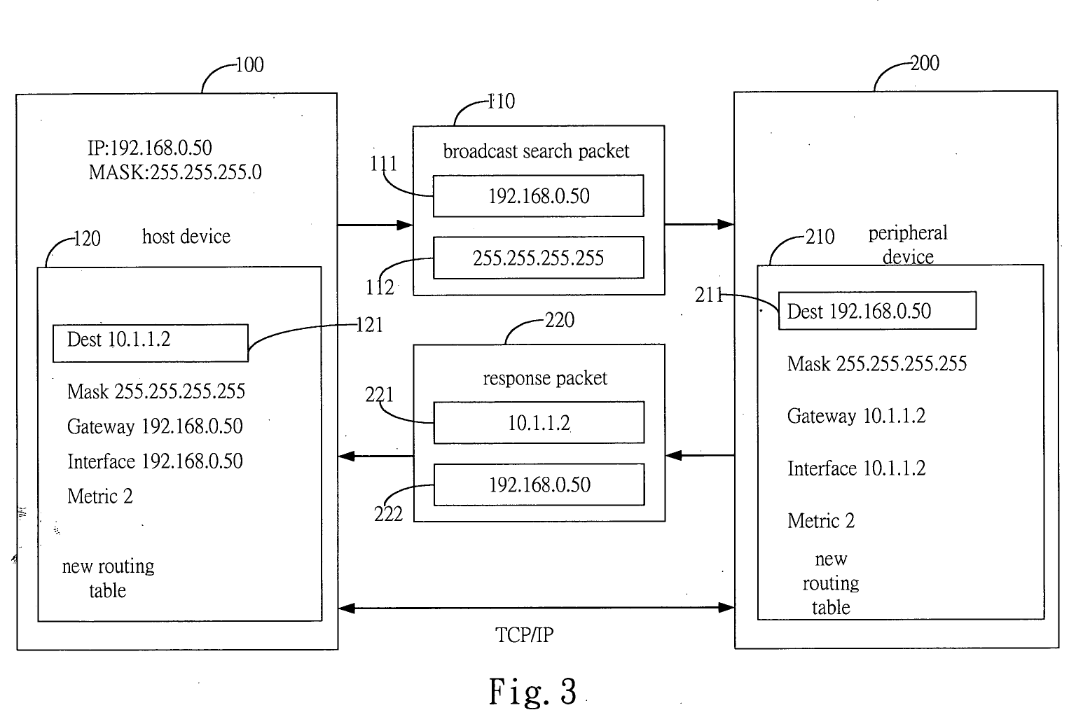

FIG. 3 shows an example of the operation of the method of communication in LAN without setting IP of the present invention. The IP address of the host device 100 is 192.168.0.50, and the mask address is 255.255.255.0. The source address 111 of the broadcast search packet 110 is 192.168.0.50. The generation of the source address 111 is not limited to the specific method. In this embodiment, the IP is pre-determined by default. Other methods, such as address generation by function computation or MAC address computing are also within the scope of the present invention. The destination address 112 of the broadcast search packet 110 is 255.255.255.255. The default IP address of the peripheral device 200 is 10.1.1.2. The destination 211 of the routing table 210 of the peripheral device 200 is 192.168.0.50, which is the IP address of the host device 100. The source address 211 of the response packet 220 is 10.1.1.2, which is the default IP address of the peripheral device 200. The generation of the source address 221 is not limited to the specific method. In this embodiment, the IP is pre-determined by default. Other methods, such as MAC address generation by hashing or computing are also within the scope of the present invention. The destination address 222 is 192.168.0.50. The destination address 121 of the routing table 120 of the host device 100 is 10.1.1.2, which is the IP address of the peripheral device. Therefore, the host device 100 and the peripheral device 200 can automatically connect for communication according to TCP/IP without manually setting IP address and gateway address.

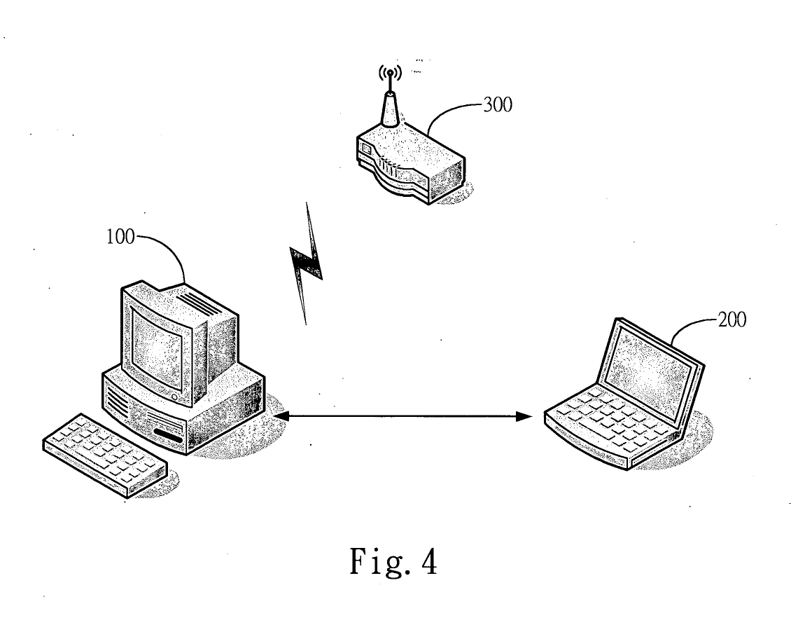

FIG. 4 shows a schematic view of an actual application of the method in a LAN. The host device 100 and the peripheral device 200 are not limited to any specific type. As shown in FIG. 4, the host device 100 is a desk-top computer, the peripheral device 200 is a notebook PC, and the peripheral device 300 is a wireless router. The host device 100 can communicate with the peripheral devices 200, 300 through wired or wireless connection. The method of FIG. 1 enables the host device 100 to automatically detect the peripheral devices 200, 300, and the peripheral devices 200, 300 to automatically execute the LAN connection. Therefore, the method of the present invention enables the host device 100 and the peripheral devices 200, 300 to communicate in LAN without setting IP by network administrative professional personnel.

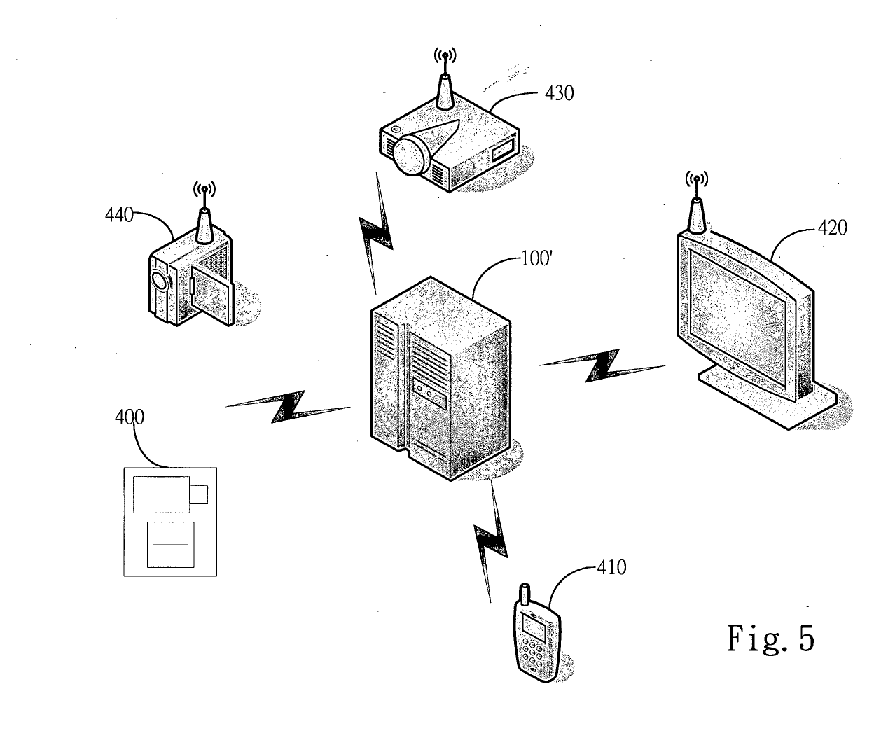

FIG. 5 shows another embodiment of the present invention in a LAN with embedded devices. The embodiment shows the operation of a digital family control system using a LAN connection. As shown in FIG. 5, a host device 100′ is a wireless network digital controller, serving as the core of the digital family control system for controlling peripheral devices 400, 410, 420, 430, 440. The peripheral device 400 is a wireless card reader for providing access control data to the host device 100′ to control the gate access. The peripheral device 410 is a wireless remote control for providing activation or deactivation and command input to the peripheral devices 400, 420, 430, 440. The peripheral device 420 is a digital TV set, the peripheral device 430 is a projector, and the peripheral device 440 is a video camera, all controlled by the wireless network. Through the method of the present invention, the peripheral devices 400, 410, 420, 430, 440 can connect to the host device 100′ for wireless communication. In addition, regardless of the embedded device in the LAN of the digital family control system, no professional network administrative personnel is required for setting the IP of the devices or other hardware.

While the invention has been described in connection with what is presently considered to the best modes for carrying out the present invention, it is to be understood that the invention is not to be limited to the disclosed embodiment, but on the contrary, is intended to cover various modifications and equivalent arrangement included within the spirit and scope of the appended claims.

What is claimed is:

1. A method of communication in LAN without setting IP, said method comprising:
(A) a host device sending a broadcast search packet through LAN to at least a peripheral device, the broadcast search packet comprising an IP address of said host device;
(B) the peripheral device establishing a new routing table according to the broadcast search packet in step (A), the new routing table having a destination address being the IP address of the host device;
(C) the peripheral device returning a response packet to the host device according to the new routing table in step (B), the response packet comprising an IP address of the peripheral device;
(D) the host device establishing a new routing table according to the response packets from the peripheral devices of step (C); and
(E) the host device using the new routing table of step (D) and the peripheral devices using the new routing table of step (B) to connect to each other and communicate according to TCP/IP.

2. The method as claimed in claim 1, wherein the broadcast search packet of step
(A) comprises a source address and a destination address.

3. The method as claimed in claim 2, wherein the source address of the broadcast search packet is the default IP address of the host device.

4. The method as claimed in claim 2, wherein the source address of the broadcast search packet is computed using MAC address.

5. The method as claimed in claim 2, wherein the source address of the broadcast search packet is generated by a function computation.

6. The method as claimed in claim 1, wherein the destination address of the new routing table of step (B) is the source address of the broadcast search packet of step (A).

7. The method as claimed in claim 1, wherein the response packet returned by the peripheral device in step (C) comprises a source address and a destination address.

8. The method as claimed in claim 7, wherein the source address of the response packet is the default IP address of the peripheral device.

9. The method as claimed in claim 7, wherein the source address of the response packet is computed using MAC address.

10. The method as claimed in claim 7, wherein the source address of the response packet is generated by a function computation.

11. The method as claimed in claim 1, wherein the destination address of the new routing table of step (D) is the source address of the source packet of step (C).
